(19) United States
(12) Patent Application Publication
(10) Pub. No.: US 2018/0283347 A1
(43) Pub. Date: Oct. 4, 2018

(54) SYSTEM FOR CONVERTING KINETIC ENERGY OF OCEAN WAVES INTO ELECTRICAL ENERGY

(71) Applicant: Menash ELI-NOVAK, Holon (IL)

(72) Inventor: Menash ELI-NOVAK, Holon (IL)

(21) Appl. No.: 15/763,875

(22) PCT Filed: Oct. 6, 2016
(86) PCT No.: PCT/IL2016/051082

§ 371 Date: Mar. 28, 2018

(30) Foreign Application Priority Data
Oct. 8, 2015 (IL) 241989

(51) Int. Cl. F03B 13/18; F16H 25/20; F16H 19/04; F16H 31/00

(52) U.S. Cl. CPC F03B 13/186; F03B 13/1855; F05B 2260/421; F16H 19/04; F16H 31/001; F16H 25/2025

(57) ABSTRACT

The present invention relates to a system of converting kinetic energy into electrical energy, comprising: at least one element that produces kinetic energy; a shaft coupled to the at least one element and configured to reciprocate in a vertical direction, whereby a linear movement of at least one element exerts a pressure for enabling the reciprocation in vertical direction, wherein said shaft serves as a vertically elevated poll; and a flywheel fastened to the shaft and configured to receive and store one-way rotational energy from said shaft, wherein the form of the shaft facilitate the rotational movement of the flywheel, thereby enabling to use the rotational energy for the generation of electricity.

### FIELD OF THE INVENTION

The present invention relates to the field of energy converting system. More particularly, the invention relates to a system for generating electrical energy from an existing resource that produces kinetic energy (e.g., sea waves) by activating a flywheel for storing rotational energy.

### BACKGROUND OF THE INVENTION

In the prior-art, there have been several attempts of converting kinetic energy into electrical energy. Most of such attempts were directed to the conversion of sea wave energy (as the source of the kinetic energy) into electrical energy. However, the solutions provided by such attempts have been largely ineffective. For example, U.S. Pat. No. 7,076,949 discloses a system for multiple harnessing and complemented conversion of energy from sea waves. The system includes a structure of vertical guides along which the central floating body moves, a submerged captive-air tank, held up by the floating body, with the body and the tank so arranged that the movement of the submerged tank is contrary to that of the central floating body. The movement of the central floating body and of the submerged tank is transmitted to the means of conversion of the movement into pneumatic, electrical or hydraulic energy.

It is an object of the present invention to provide a system which is capable of effectively converting existing resource of kinetic energy into electrical energy.

Other objects and advantages of the invention will become apparent as the description proceeds.

### SUMMARY OF THE INVENTION

The present invention relates to a system of converting kinetic energy into electrical energy, comprising: at least one element that produces kinetic energy (e.g., a floating element in case of exploiting the movement of ocean waves); a shaft coupled to the at least one element and configured to reciprocate in a vertical direction, whereby a linear movement of said at least one element exerts a pressure for enabling the reciprocation in vertical direction, wherein said shaft serves as a vertically elevated poll; and a flywheel fastened to the shaft and configured to receive and store one-way rotational energy from said shaft, wherein the form of the shaft facilitate the rotational movement of the flywheel, thereby enabling to use the rotational energy for the generation of electricity.

According to an embodiment of the invention, the shaft is having a twisted form of a helical ridge that performs the reciprocation in vertical direction while being threated through the center of the flywheel, wherein said shaft is coupled to said flywheel via a one-way bearing mechanism, thereby enabling said flywheel to receive and store one-way rotational energy from said shaft.

According to an embodiment of the invention, the shaft is having a serrated form that performs the reciprocation in vertical direction while moving across the diameter of the flywheel, wherein said shaft is coupled to the flywheel via a one-way tooth-wheel mechanism, thereby enabling said flywheel to receive and store one-way rotational energy from said shaft.

According to an embodiment of the invention, the system further comprises a main gear coupled to the flywheel for receiving the rotational energy, whereby the flywheel configured to transfer the stored rotational energy for enabling a continuous rotation of the main gear.

According to an embodiment of the invention, the system further comprises a generator comprising a gear system, whereby a rotation of the main gear over the gear system enables the generation of electricity.

According to an embodiment of the invention, the at least one element that produces kinetic energy is a floating element that is adapted to convert the kinetic energy of ocean waves into the linear movement due its floating capabilities. According to an embodiment of the invention, the system further comprises additional floating elements, each of which coupled to the twisted shaft by an elevated supporting arm for facilitating the vertical movement of the twisted shaft.

According to an embodiment of the invention, the twisted shaft is coupled to the flywheel through a one-way bearing element or system for facilitating the rotational movement, thereby transmitting torque between the twisted shaft and the flywheel in one direction and allowing free motion in the opposite direction. Preferably, the bearing element is a tapered roller bearing.

### BRIEF DESCRIPTION OF THE DRAWINGS

In the drawings:

FIG. 1 is a perspective view of an embodiment of a system for converting kinetic energy of ocean waves into electrical energy, according to an embodiment of the present invention;

FIG. 2 schematically illustrates a top view of the system of FIG. 1;

FIG. 3A schematically illustrates a perspective view of an exemplary tapered roller bearing that can be used in conjunction with system of the present invention;

FIG. 3B schematically illustrates a cross-sectional view of the exemplary tapered roller bearing;

FIG. 4 schematically illustrates a cross-sectional view of the upper section of the system that includes a flywheel;

FIGS. 5A-5C schematically illustrate exemplary variations of a twisted shaft that serves as a vertically elevated poll, according to an embodiment of the present invention;

FIG. 6A schematically illustrates a front view of a system for converting kinetic energy of ocean waves into electrical energy, according to another embodiment of the present invention; and

FIG. 6B schematically illustrates a side view of the system of FIG. 6A.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

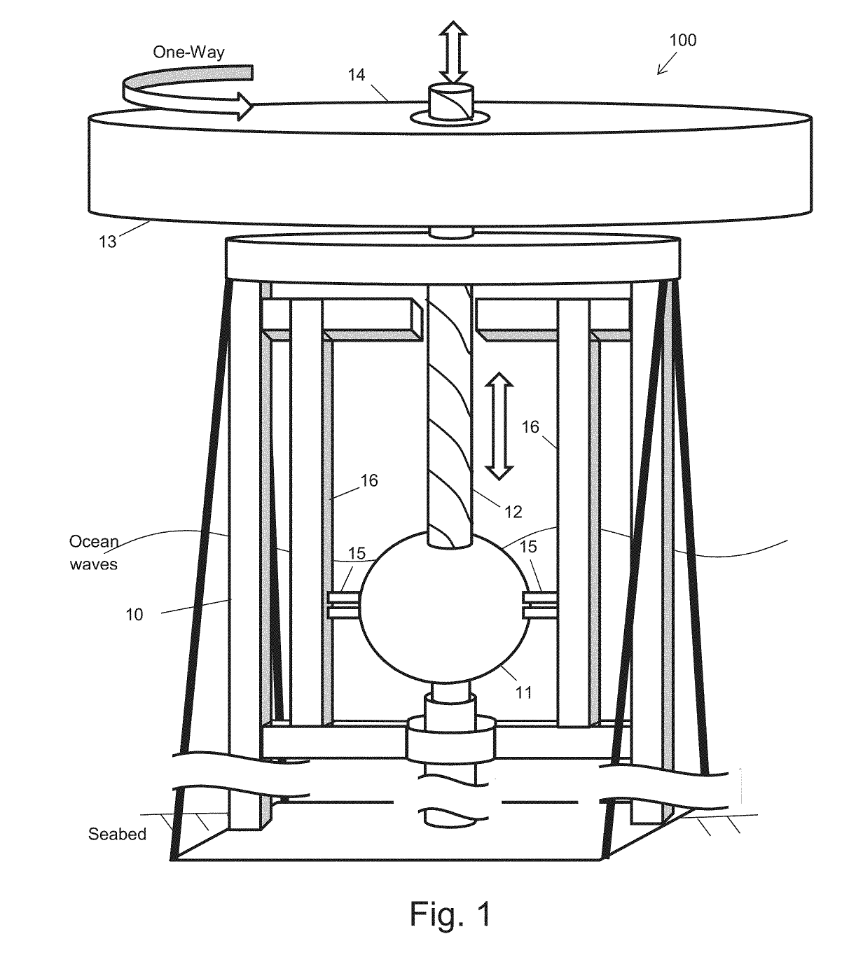

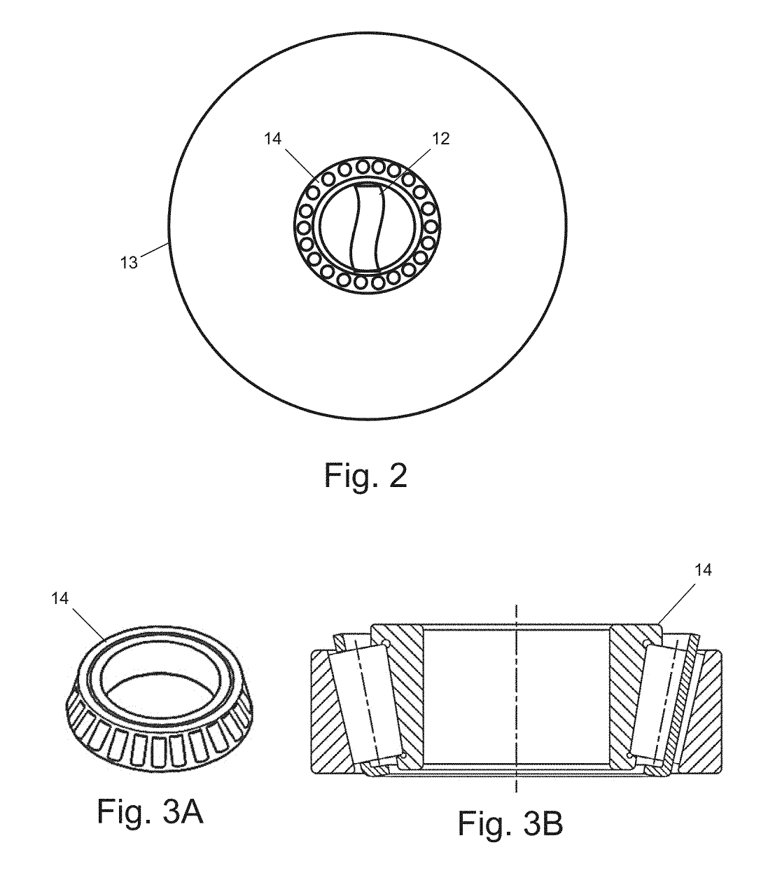

With reference to FIGS. 1 and 2, designated by the reference number 100 is an exemplary system for generating electrical energy from sea waves. It should be noted that the figures illustrate the system 100 in an altogether schematic way in order to enable an immediate understanding of its most important features that distinguish it from systems of a known type. It is consequently evident that the embodiment of the system may even vary from the one illustrated herein according to the processes, materials, and/or means that the person skilled in the art will deem most appropriate to adopt for production of the system. Moreover, the principles described herein for converting kinetic energy into electrical energy with respect to natural resource such as ocean waves, can be employed mutatis mutandis in other systems as to exploit the kinetic energy that is already exist in such systems, in order to produce electrical energy. For example, such principles can be used to produce electrical energy from the kinetic movement of a mechanical or hydraulic device designed to absorb and damp shock impulses, such as the suspension system of a car, in particular from the shock absorber elements of the suspension system of the car. The size and dimension of the elements that will be described herein with respect to the example of ocean waves, of course should be adapted depending on each specific implementation. For example, in case of using the system to generate electrical energy from the suspension system of the car, the dimension of the different elements should be reduce with respect to those needed for producing energy from the sea waves.

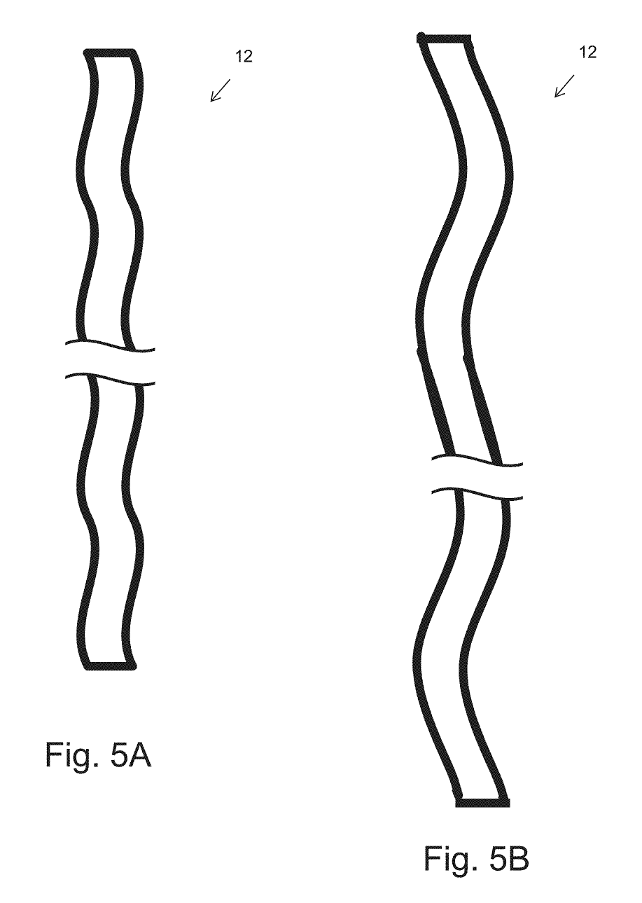

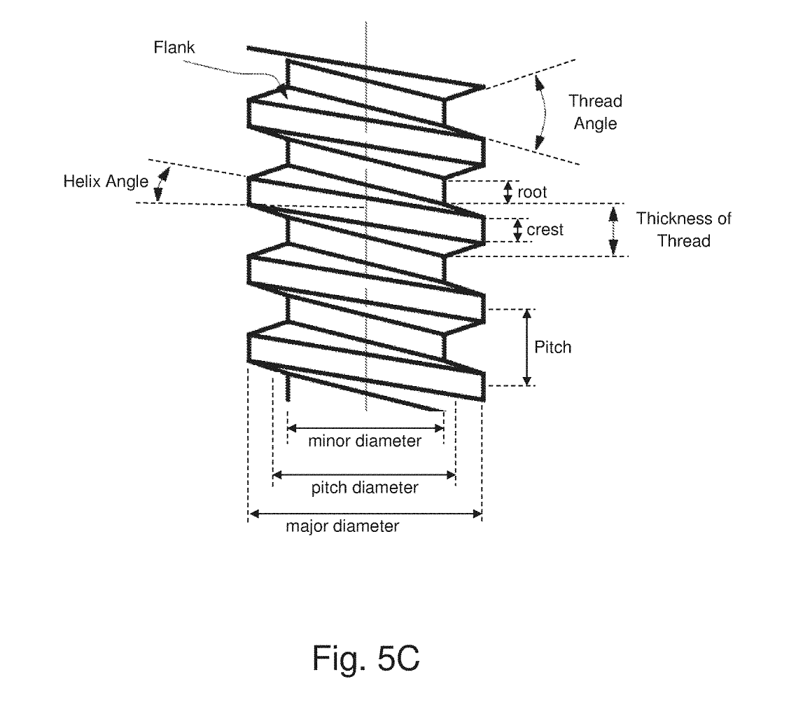

System 100 configured for producing electrical energy by absorption of ocean wave energy utilizing at least one element that produces kinetic energy (in this embodiment the least one element refers to a floating element or a moveable float 11) and a twisted shaft 12 that serves as a vertically elevated poll. For example, the twisted shaft 12 may have a form of a helical ridge wrapped around a cylinder. Such form enables to facilitate the rotation of shaft 12. FIGS. 5A and 5B schematically illustrate exemplary variations of the twisted shaft 12. The twisted shaft 12 used to magnify motion and force, and to convert rotation to linear motion. FIG. 5C schematically illustrates a portion of a twisted shaft showing the difference parameters that might be considered when designing the twisted shaft, such as helix angle, thread angle, thickness of thread, etc.

According to a non-limiting exemplary embodiment of the present invention, float 11 is placed in an ocean and is coupled to the twisted shat 12. The float 11 and shaft 12 are positioned within a supporting frame 10 that is partially placed in a predetermined depth in the ocean. Frame 10 includes rails 16 that serve as a guiding rail for the vertical movements of float 11. Float 11 can be coupled to rails 16 via slideable members 15, each adapted to slide along the path of a corresponding guiding rail 16. Each slideable member 15 is fixed to the float 11 at one end while its other end is situated in the corresponding guiding rail 16. Float 11 may have a spherical form or any other form suitable to facilitate the movements of the waves across the body of the float 11. Frame 10 is anchored or fix to the seabed of the ocean.

System 100 receives a pressure exerted by the movable float 11. The pressure exerted by the movable float 11 enables a vertical and linear movement of the twisted shaft 12. A flywheel 13 is coupled to the distal end of shaft 12 using a one-way bearing 14 (or other element or gear element that is suitable for facilitating the desired rotational motion of flywheel 13 as much as possible), such that the one-way bearing 14 is designed to transmit torque between the shaft 12 and the flywheel 13 in one direction and allow free motion in the opposite direction. Shaft 12 serves as an axle at the center of the flywheel 13. System 100 converts the linear motion of the twisted shaft 12 into one-way rotational motion by rotating the flywheel 13 only at one direction (e.g., clockwise or counterclockwise depending on the configuration of the system).

According to an embodiment of the invention, bearing 14 can be a tapered roller bearing (i.e., a conical bearing as shown in FIGS. 3A and 3B) that can take large axial forces as well as being able to sustain large radial forces. The tapered roller bearings can be based on the observation that cones that meet at a point can roll over each other without slipping. In practice, sections of cones can be used. For example, the inner and outer ring raceways (i.e., the rolling-elements of a rolling-element bearing ride on races. The large race that goes into a bore is called the outer race, and the small race that the shaft rides in is called the inner race) are segments of cones and the rollers are also made with a taper so that the conical surfaces of the raceways and the roller axes if projected, would all meet at a common point on the main axis of the bearing. This conical geometry is used as it gives a larger contact patch, which permits greater loads to be carried than with spherical (ball) bearings, while the geometry means that the tangential speeds of the surfaces of each of the rollers are the same as their raceways along the whole length of the contact patch and no differential scrubbing occurs.

The float 11 may include but not limited to wood, plastic and metal or any element or structure that has floating property. The float 11 may be operated under the water or above the water. Although in this embodiment, the system is configured in such a way that the flywheel 13 is located above the water; in other embodiments the system can be configured in such a way that the flywheel 13 will be located under the water.

According to an embodiment of the invention, in some configurations the system may convert the linear motion of the twisted shaft 12 into two-way rotational motion by utilizing the rotation of the flywheel 13 at both direction (i.e., clockwise and counterclockwise).

The twisted form of the shaft 12 (i.e., the vertically elevated poll) and the bearing 14 enable the rotation of the flywheel 13 in one direction only. According to some embodiments of the invention, the system 100 may include other one-way gears including but not limited to clutch, ball bearings, roller bearings and the like. Flywheel 13 is fastened to the center of shat 12 and configured to receive an energy applied by float 11 through the vertically elevated poll (i.e., shaft 12) and rotates for transferring the rotational energy to a suitable mechanism such as a main gear (not shown). The flywheel 13 is configured to conserve or store the energy transferred by shaft 12 for enabling a continuous rotation of the system. For example, the main gear can be configured to run over a generator gear attached to a shaft extending from a generator. The rotation of the generator gear enables a generation of the electricity by the generator.

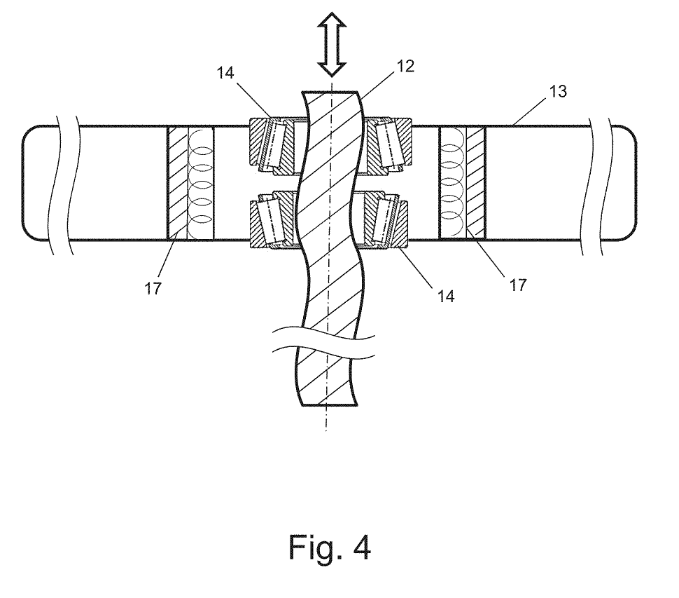

In various embodiments, the system comprises electric-generator means connected to the rotational element so as to exploit the kinetic energy associated thereto for generating electrical energy. For example, FIG. 4 schematically illustrates a cross-section view of the upper portion of system 100 that includes the flywheel 13. In this exemplary embodiment, at least parts of an electric generator are embedded within the flywheel 13 as indicated by numeral 17. The means will not be described herein in detail in so far as they are already widely known in the relevant art. For the reasons that will be evident in what follows to a person skilled in the art, the electric-generator means used in the system described herein are preferably of the rotary type. In various embodiments, as in the one illustrated, the system further comprises means for storing the electrical energy produced, such as for example a set of batteries (not shown), which are electrically connected to the generator means.

According to a non-limiting exemplary embodiment of the present subject matter, the system includes additional floating elements, each coupled to shaft 12 via one or more supporting arms.

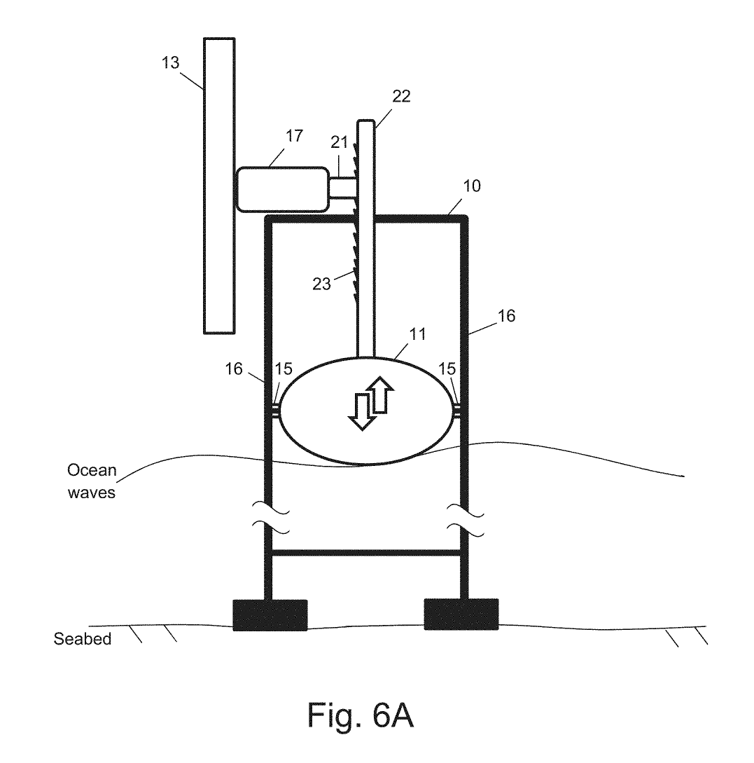

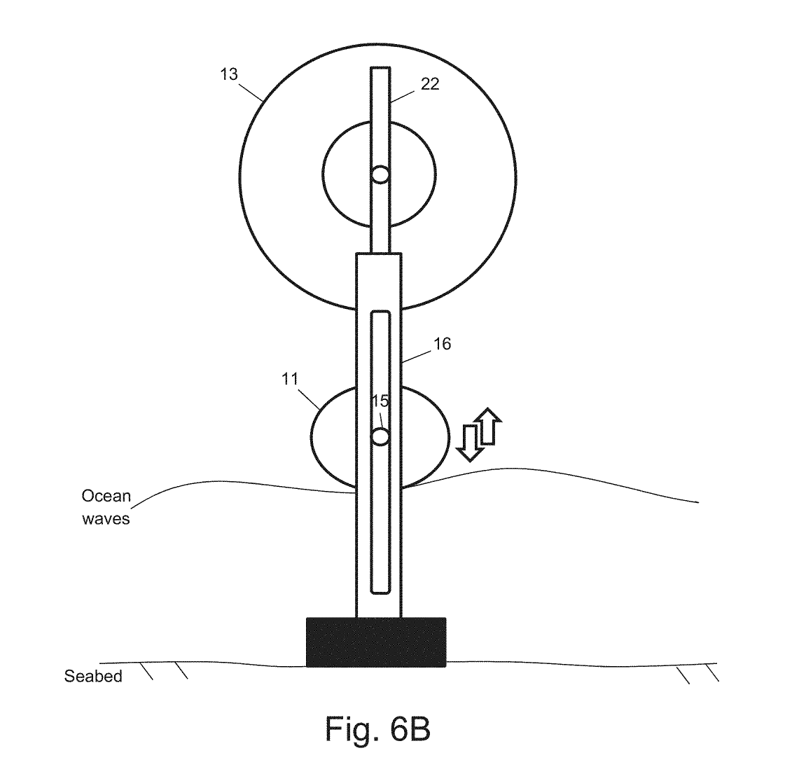

FIGS. 6A and 6B schematically illustrate a system for converting kinetic energy of ocean waves into electrical energy, according to another embodiment of the present invention. In this embodiment, the vertically elevated poll is provided by a serrated shaft 22. Shaft 22 has a serrated form (as indicated by numeral 23) that performs the reciprocation in vertical direction while moving across the diameter of the flywheel 13. The serrated shaft 22 is coupled to the flywheel 13 via a one-way tooth-wheel mechanism 21, thereby enabling the flywheel 13 to receive and store one-way rotational energy from shaft 22. An electric generator 17 can be coupled to the flywheel 13 and be position between the shaft 22 and the flywheel 13 as shown in FIG. 6A.

As will be appreciated by the skilled person the arrangement described in the figures results in a system which is capable of effectively converting kinetic energy of ocean waves into electrical energy. As emerges from the above description, the system described herein envisages an operation in which the system expends energy for synchronizing with the action of the sea waves on the floating body, but by so doing is able to exploit in an optimal way the torques induced by the wave motion, reducing as much as possible the losses of energy due to the twisted structure of the rod. The present applicant has in this connection found that the system described herein presents levels of operating efficiency that are higher than those obtained in systems of a known type. In addition, as aforementioned, the principles described hereinabove can be employed mutatis mutandis in other systems as to exploit the kinetic energy that is already exist in such systems to produce electrical energy. For example, such principles can be used to produce electrical energy from the kinetic movement of a mechanical or hydraulic device designed to absorb and damp shock impulses, such as the suspension system of a car, or in particular from the shock absorber elements of the suspension system.

The terms, “for example”, “e.g.”, “optionally”, as used herein, are intended to be used to introduce non-limiting examples. While certain references are made to certain example system components, other components can be used as well and/or the example components can be combined into fewer components and/or divided into further components. All the above description and examples have been given for the purpose of illustration and are not intended to limit the invention in any way. Many different mechanisms and mechanical elements can be employed, all without exceeding the scope of the invention to produce electric energy from an existing source of kinetic energy whether it is a natural resource such as the ocean waves or mechanical resource such as the suspension system of a car.

What is claimed is:

1. A system of converting kinetic energy into electrical energy, comprising:
a) at least one element that produces kinetic energy;
b) a shaft coupled to the at least one element and configured to reciprocate in a vertical direction, whereby a linear movement of said at least one element exerts a pressure for enabling the reciprocation in vertical direction, wherein said shaft serves as a vertically elevated poll; and
c) a flywheel coupled to the shaft and configured to receive and store one-way rotational energy from said shaft, wherein the form of the shaft facilitate the rotational movement of the flywheel, thereby enabling to use the rotational energy for the generation of electricity.

2. A system according to claim 1, in which the shaft is having a twisted form of a helical ridge that performs the reciprocation in vertical direction while being threated through the center of the flywheel, wherein said shaft is coupled to said flywheel via a one-way bearing mechanism, thereby enabling said flywheel to receive and store one-way rotational energy from said shaft.

3. A system according to claim 1, in which the shaft is having a serrated form that performs the reciprocation in vertical direction while moving across the diameter of the flywheel, wherein said shaft is coupled to said flywheel via a one-way tooth-wheel mechanism, thereby enabling said flywheel to receive and store one-way rotational energy from said shaft.

4. A system according to claim 1, further comprising a main gear coupled to the flywheel for receiving the rotational energy, whereby the flywheel configured to transfer the stored rotational energy for enabling a continuous rotation of the main gear.

5. A system according to claim 4, further comprising a generator comprising a gear system, whereby a rotation of the main gear over the gear system enables the generation of electricity.

6. A system according to claim 1, in which the at least one element that produces kinetic energy is a floating element that is adapted to convert the kinetic energy of ocean waves into a linear movement due its floating capabilities.

7. A system according to claim 6, further comprising additional floating elements, each of which coupled to the twisted shaft by an elevated supporting arm for facilitating the vertical movement of the twisted shaft.

8. A system according to claim 1, in which the twisted shaft is coupled to the flywheel through a one-way bearing element or system for facilitating the rotational movement, thereby transmitting torque between the twisted shaft and the flywheel in one direction and allowing free motion in the opposite direction.

9. A system according to claim 1, in which the bearing element is a tapered roller bearing.
